(19) United States
(12) Patent Application Publication
(10) Pub. No.: US 2019/0112048 A1
(43) Pub. Date: Apr. 18, 2019

(54) SYSTEMS AND METHODS FOR UNMANNED AERIAL VEHICLES

(71) Applicant: Matthew CULVER, Eau Claire, WI (US)

(72) Inventor: Matthew CULVER, Eau Claire, WI (US)

(21) Appl. No.: 16/090,176

(22) PCT Filed: Mar. 29, 2017
(86) PCT No.: PCT/US17/24772

§ 371 Date: Sep. 28, 2018

Related U.S. Application Data
(60) Provisional application No. 62/315,522, filed on Mar. 30, 2016.
(60) Provisional application No. 62/349,471, filed on Jun. 13, 2016.

(51) Int. Cl. B64C 39/02; B64D 47/08; G09F 21/12

(52) U.S. Cl. CPC B64C 39/024; B64D 47/08; G05D 1/0094; B64C 39/022; G09F 21/12

(57) ABSTRACT

An unmanned aerial system (UAS) may comprise an unmanned aerial vehicle (UAV) configured to display advertising. The UAV may include a connector configured to attach to a display screen. The display screen may be configured to receive data from the UAV and display a message based on the data. The UAS may be controlled by a remote control, which may command the UAV to display a specific message. The remote control may control the flight of the UAV as well as the functionality of the one or more components. The components attached to the UAV, may include a camera, a robotic arm, or a display screen. The UAS may be configured to, for example, display advertising messages in a predetermined area, display advertising messages in response to the UAV determining a specific event or recognizing a specific person, and/or launch fireworks.

### RELATED APPLICATIONS

This application claims priority to U.S. Provisional Application Nos. 62/315,222 (filed Mar. 30, 2016) and 62/349,471 (filed Jun. 13, 2016), which are incorporated herein by reference in their entirety.

### BACKGROUND

### Technical Field

This disclosure relates generally to unmanned aerial vehicles. More specifically, this disclosure relates to systems and methods for providing advertising and providing surveillance during recreational events.

### Background Description

The use of unmanned aerial vehicles (UAVs), also referred to as drones, has increased drastically in popularity throughout the last decade while consumer UAVs have decreased in price. Other technologies, such as lightweight cameras with high resolutions and smart phones configured to control Unmanned Aerial Systems (UASs) (e.g., UAVs and associated systems), have further increased the speed at which consumers adopt these devices.

Today, many industries make use of UASs such as film makers, oil platform workers, militaries, and law enforcement. For example, film makers and television producers may use UASs that carry cameras to capture video that they otherwise could not capture using low-cost camera rigs. As opposed to using a platform or cable-suspended camera system to acquire overhead views, UASs may fly into the air and, with the help of a remote display, capture video from an overhead angle. Similarly, oil platform workers are able to use UASs to view portions of oil platforms that may need repair, without the need for a worker to put themselves in a dangerous position. For example, a UAS may fly around an oil platform over water, which eliminates the risks faced by workers hanging over an edge of a platform by a rope to examine platform supports. Military and law enforcement, likewise, may use UASs to gather intelligence without placing themselves in dangerous positions where they may be injured. UASs allow military and law enforcement to view areas from overhead without risking the life of a pilot or a person attempting to enter a potentially dangerous area.

As technology continues to improve and decrease in cost, an increasing amount of hobbyists are using UASs for various purposes. Hobbyists use UASs to capture overhead video of their homes, which was previously difficult to achieve at such a low cost. Hobbyists may also use the video capturing capabilities of UASs to capture video of themselves as they hike up a mountain, skate board down a hill, or go river rafting. In some UASs, a UAV may be configured to automatically hover at a particular height and distance from a remote control such as a smart phone or a radio transmitter. Thus, as a hobbyist rolls down a hill or floats down a river, they are able to single-handedly obtain a professional looking video that is taken from a fixed distance and height.

One problem faced by UASs is their ability to perform tasks that would normally be done by multiple different systems, such as outdoor advertising. Outdoor advertising involves attaching signs, banners, etc., to temporary or permanent structures. There can be significant costs involved with the display of advertisements. The use of UAVs in advertising may reduce costs and increase flexibility of timing and placement of advertisements.

Another problem faced by UASs is their ability to perform tasks usually reserved for stationary platforms. UAVs used for recreational activity surveillance and assistance are typically small in size and portable. But these UAVs must be able to carry equipment such as cameras and recreational equipment, and occasionally heavier items such as golf clubs. Due to their size, UAVs often require small, lightweight batteries that tend to run out of power quickly. In particular, the heavier a UAV and its payload is, the faster it typically runs out of power. To overcome this problem, tethers are often used to power UAVs. Tethered UASs are able to operate for longer periods of time without running out of power. However, tethers often introduce their own problems such as portability. For example, a tether may be connected to a power converter, which in turn may need to be connected to an electric outlet. In such an example, a UAV's range is limited to the length of the tether and a power cord connecting the converter to an outlet. Thus, there is a need in the art for a UAV to be able to carry heavy recreational equipment and/or fly for extended periods of time during a recreational event, without being limited by its distance from a fixed power outlet.

UAVs used in advertisement may typically be small in size and portable. But these UAVs must be able to carry equipment such as LED screens, projectors, banners, and occasionally heavier advertising equipment. Due to their size, UAVs often require small, lightweight batteries that tend to run out of power quickly. In particular, the heavier a UAV and its payload is, the faster it typically runs out of power. To overcome this problem, tethers are often used to power UAVs. Tethered UASs are able to operate for longer periods of time without running out of power. However, tethers often introduce their own problems such as portability. For example, a tether may be connected to a power converter, which in turn may need to be connected to a power source, such as an electrical outlet. In such an example, a UAV's range is limited to the length of the tether and a power cord connecting the converter to an outlet. Thus, there is a need in the art for a UAV configured to provide advertising to be able to carry heavy equipment and/or fly for extended periods of time, without being limited by its distance from a fixed power source.

The present disclosure is directed toward improvements in existing technologies for unmanned aerial systems.

### SUMMARY

In an exemplary embodiment, the present disclosure is directed to unmanned aerial systems (UASs) that include at least one unmanned aerial vehicle (UAV) that may carry a display screen. A UAV may comprise one or more carrying components, which may be included in or attached to the UAV. The UAV may be configured to display advertising messages using the display screen. The UAV may be configured to take off and land on a platform and return to the platform in severe weather or for maintenance. In another exemplary embodiment, a UAV may comprise a controller for controlling the UAV and/or attachments to the UAV. UASs may also comprise a power source, which may be portable, configured to power a UAV. In another embodiment, the UAV may include projector. The projector may be configured to project an advertising message in response to data transmitted by the UAV.

In another exemplary embodiment, the present disclosure is directed to a method of displaying advertising messages using a UAV. The UAV may be attached to a display screen, navigate from a platform, and transmit data to the display screen to display an advertising message while the UAV is navigating. The UAV may be further configured to return to the platform after displaying the advertising message.

In another exemplary embodiment, the present disclosure is directed to unmanned aerial systems (UASs) that include at least one unmanned aerial vehicle (UAV) and at least one controller configured to transmit one or more commands to the UAV. The UAV may have a connector configured to carry a display screen. The UAS may also include a power source configured to provide power to the UAV.

Additional objects and advantages of the present disclosure will be set forth in part in the following detailed description, and in part will be obvious from the description, or may be learned by practice of the present disclosure. The objects and advantages of the present disclosure will be realized and attained by means of the elements and combinations particularly pointed out in the appended claims.

It is to be understood that the foregoing general description and the following detailed description are exemplary and explanatory only, and are not restrictive of the disclosed embodiments.

### BRIEF DESCRIPTION OF DRAWINGS

The accompanying drawings, which comprise apart of this specification, illustrate several embodiments and, together with the description, serve to explain the disclosed principles. In the drawings:

FIG. 1 illustrates exemplary unmanned aerial vehicles, consistent with disclosed embodiments.

FIG. 2 illustrates an exemplary unmanned aerial system having a portable power source and a tether, consistent with disclosed embodiments.

FIG. 3 illustrates an exemplary unmanned aerial system having a portable power source and a tether, consistent with disclosed embodiments.

FIG. 4 illustrates exemplary remote controls, consistent with disclosed embodiments.

FIG. 5 illustrates a block diagram of an exemplary unmanned aerial system, consistent with disclosed embodiments.

FIG. 6 illustrates an exemplary portable power source and tether, consistent with disclosed embodiments.

FIG. 7 illustrates an exemplary unmanned aerial system having a connector, consistent with disclosed embodiments.

FIG. 8 illustrates an exemplary unmanned aerial system having a camera, consistent with disclosed embodiments.

FIG. 9 illustrates an exemplary unmanned aerial system having a robotic arm, consistent with disclosed embodiments.

FIG. 10 illustrates an exemplary unmanned aerial system having quick-disconnect battery, consistent with disclosed embodiments.

FIG. 11 illustrates an exemplary environment including an unmanned aerial vehicle and an advertising banner, consistent with disclosed embodiments.

FIG. 12 illustrates an exemplary environment including unmanned aerial vehicles and display screens for advertising, consistent with disclosed embodiments.

FIG. 13 illustrates an exemplary environment including unmanned aerial vehicles and a projector and screen, consistent with disclosed embodiments.

FIG. 14 illustrates an exemplary environment including unmanned aerial vehicles and a fireworks launching pad, consistent with disclosed embodiments.

FIG. 15 illustrates an exemplary environment including unmanned aerial vehicles and light projectors, consistent with disclosed embodiments.

FIG. 16 illustrates an exemplary environment including an unmanned aerial vehicle and a portable landing pad, consistent with disclosed embodiments.

FIG. 17 illustrates an exemplary environment including an unmanned aerial vehicle and a portable landing pad attached to recreational vehicles, consistent with disclosed embodiments.

FIG. 18 illustrates an exemplary environment including an unmanned aerial vehicle and items that need to be carried, consistent with disclosed embodiments.

FIG. 19 illustrates an exemplary unmanned aerial system and a display component, consistent with disclosed embodiments.

FIG. 20 illustrates a web application system, consistent with disclosed embodiments.

FIG. 21 illustrates a flowchart of an exemplary method for a unmanned aerial vehicle surveilling recreational events or individuals, consistent with disclosed embodiments.

### DETAILED DESCRIPTION

Exemplary embodiments are described with reference to the accompanying drawings. In the figures, the left-most digit(s) of a reference number identifies the figure in which the reference number first appears. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. Also, the words “comprising,” “having,” “containing,” and “including,” and other similar forms are intended to be equivalent in meaning and be interpreted as open ended, in that, an item or items following any one of these words is not meant to be an exhaustive listing of such item or items, or meant to be limited to only the listed item or items.

As used in this application and in the claims, the singular forms “a,” “an,” and “the” include the plural forms unless the context clearly dictates otherwise. Additionally, the term “includes” means “comprises.” Further, the term “coupled” does not exclude the presence of intermediate elements between the coupled items.

The systems and methods described herein should not be construed as limiting in any way. Instead, the present disclosure is directed toward all novel and non-obvious features and aspects of the various disclosed embodiments, alone and in various combinations and sub-combinations with one another. The disclosed systems and methods are not limited to any specific aspect or feature or combinations thereof, nor do the disclosed systems and methods require that any one or more specific advantages be present or problems be solved. Any theories of operation are to facilitate explanation, but the disclosed systems, methods, and apparatus are not limited to such theories of operation.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed systems, methods, and apparatus can be used in conjunction with other systems, methods, and apparatus. Additionally, the description sometimes uses terms like “produce” and “provide” to describe the disclosed methods. These terms are high-level abstractions of the actual operations that are performed. The actual operations that correspond to these terms will vary depending on the particular implementation and are readily discernible by one of ordinary skill in the art.

Reference will now be made in detail to the drawings. Herein, the terms “unmanned aerial vehicle” or “UAV” will generally refer to the powered flying portion of an “unmanned aerial system” or “UAS.” For example, a UAV may be a quadcopter, while a UAS may be a quadcopter, a tether, a portable power source, and a remote control. Other types of UAVs and/or UASs are consistent with this disclosure, such as, for example, single-propeller UAVs, fixed wing UAVs, UAVs with variable propeller pitches, UAVs with multiple propellers (e.g., 2, 4, 6, 8), UAVs with turbine engines, etc.

Systems and methods consistent with the present disclosure are directed to a UAS comprising a UAV configured to provide advertising. Various UAVs described herein may be configured to remain airborne for long periods of time and fly in diverse weather conditions. In some embodiments, a UAV may be housed on a platform near advertising area. In some embodiments, the UAV may carry an advertising banner, or other advertising device, and be configured to fly in a local area to draw people to the area. In some embodiments, a portable power source may be physically connected to a tether capable of transmitting power and data, which may in turn be connected to the UAV. A portable power source may be physically connected to a tether capable of transmitting power and data, which may in turn be connected to a UAV. In some embodiments, a tether may include a Power over Ethernet (PoE) component that connects to a WiFi enabled landing pad. In some embodiments, a portable power source may comprise one or more batteries, generators, solar panels, or other components that acquire, store, and/or transmit power to a UAV. The portable power source may be a stand-alone device that is small enough to be transported in, for example, an automobile. The power source may be removed from a vehicle, activated, and connected to a UAV to power it for longer periods of time than a battery within the UAV itself. In other embodiments, the UAV may house a battery, which can be quickly charged or swapped out for increased flight time.

In some embodiments, the UAV may include a connector that allows external components to attach to the UAV. A connector may be configured to allow a UAV to carry external advertising components. For example, external components may include a screen, spotlights, robotic arm, projectors, platforms, etc. External components may be used to display advertising messages to potential customers over a large area for a period of time.

In some embodiments, the UAV may land on an elevated landing area, a portable landing area, a remote landing area, or the like. For example, in some embodiments, the landing area may include a portable power source and be elevated such that the UAV may land or otherwise be stored such that it is not damaged. As another example, the landing area may be portable landing area that can be driven or remotely controlled to drive to a predetermined area. As another example, the landing area may be at a remote location and provide shelter for the UAV to protect it from weather or other damage. In some embodiments, the UAS may comprise functionality that causes the UAV to land on a landing pad automatically. For example, a UAV may fly for a particular period of time and, in response to an adverse weather condition, initiate a landing process wherein the UAV automatically lands on the landing pad without additional operator input. As another example, a UAV may fly for a predetermined amount of time and then automatically land on the landing pad. In some embodiments, the landing area (e.g., a platform, hanger, other surface, etc.) may be included in the UAS.

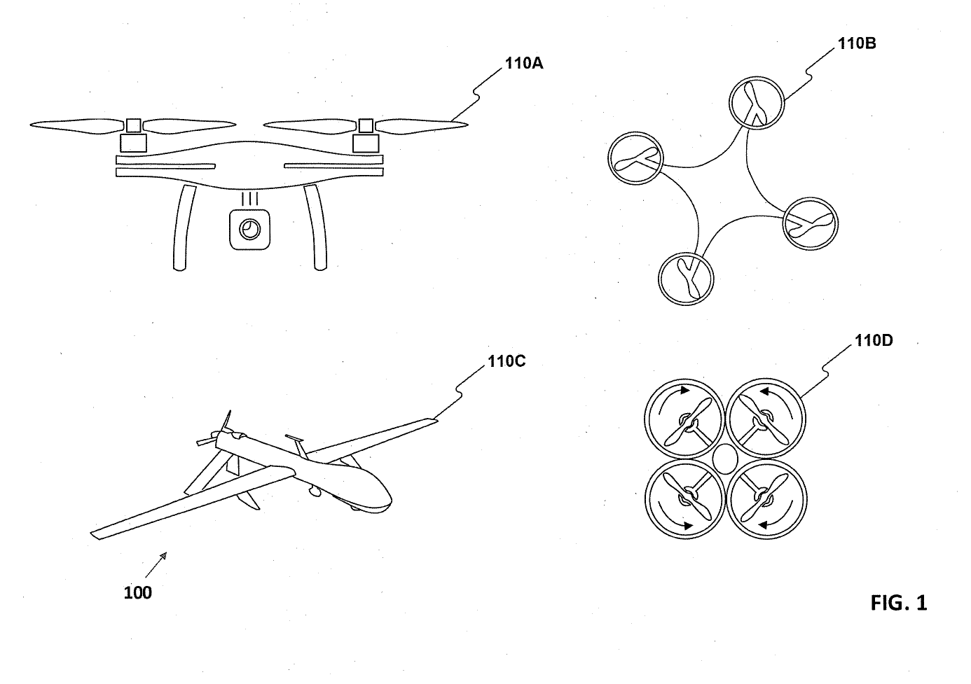

FIG. 1 illustrates exemplary unmanned aerial vehicles 100 according to some embodiments of the present disclosure. FIG. 1 includes a side view of a UAV 110A, a top view of a UAV 110B with four propellers, a UAV 110C having a rearward facing propeller, and a UAV 110D having larger propellers with propeller guards that contact one another. Exemplary UAVs 110A, 110B, and 110D may be referred to as quadcopters, although it should be appreciated that a UAV could have any number of propellers or other thrust generators. For example, a UAV may have one, two, three, four, or more propellers. In some embodiments, a UAV may have a thrust generator other than propellers, such as a turbine engine.

UAVs 110A, 110B, and 110C, may be propelled by four vertically oriented propellers, which may include two pairs of identical fixed pitched propellers wherein one pair is configured to rotate clockwise, and the second pair is configured to rotate counter-clockwise (as shown by UAV 110D). In exemplary embodiments, independent variation in the speed of each rotor may be used to control a UAV. By changing the speed of each rotor, a UAV may rotate, move forward, move backward, move higher and/or move lower. Quadcopters differ from conventional helicopters which use rotors that are able to dynamically vary the pitch of their blades as they move around a rotor hub. Generally, quadcopters are less expensive and more durable than conventional helicopters. Their smaller blades produce less kinetic energy, reducing their ability to cause damage. However, as the size of a vehicle increases, fixed propeller quadcopters become less advantageous. Larger blades increase the momentum of a UAV causing destabilization, and changes in blade speed take longer which negatively impacts control.

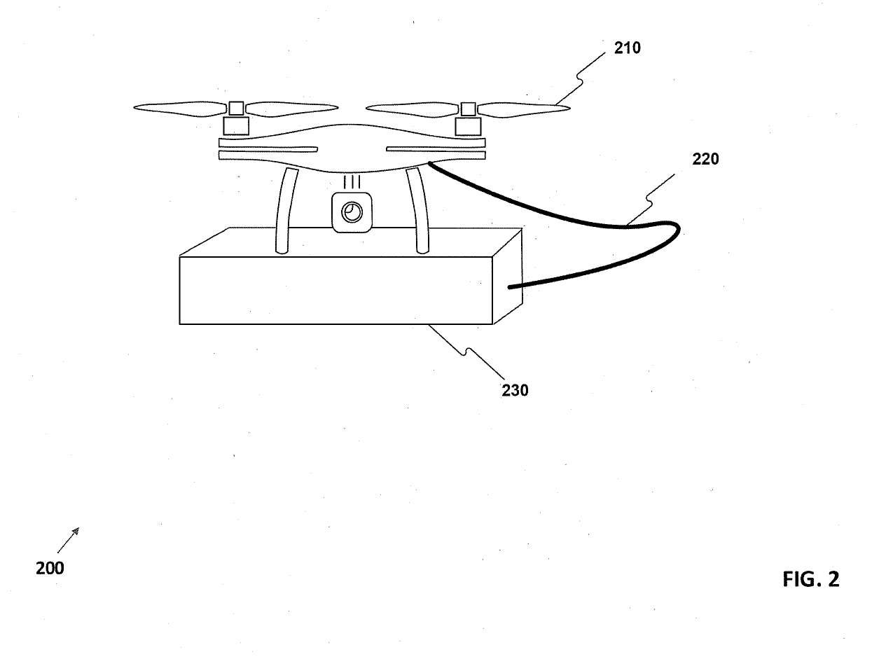

FIG. 2 illustrates an exemplary unmanned aerial system (UAS) 200 having a portable power source and a tether according to some embodiments of the present disclosure. As shown in FIG. 2, for example, UAV 210 is connected to tether 220, which is also connected to portable power source 230. Portable power source 230 may transmit data and/or power to UAV 210 via tether 220. Tether 220 may include multiple cables which may power or control various portions of UAV 210.

In some embodiments, portable power source 230 may include one or more batteries and/or individual battery cells. Batteries and/or cells included in portable power source 230 may be of the same type or different types. In some embodiments, batteries and/or cells included in portable power source 230 may be charged via a connector other than tether 220, such as a cable which may be plugged into a standard electric outlet or connected to power from a power pole. Further, it is contemplated that a plurality of portable power sources may be connected to each other to provide additional power to a UAS. Batteries and/or cells may be configured in a series, parallel, or a mixture of both to deliver a desired voltage, capacity, or power density. Portable power source 230 may include rechargeable batteries, and a temperature sensor which a battery charger may use to detect whether batteries are finished charging. Portable power source 230 may include battery regulators to keep the peak voltage of each individual battery or cell below its maximum value to allow other batteries to fully charge, such that the batteries are balanced. Portable power source 230 may include other battery balancing devices configured to transfer energy from charged batteries to less charged batteries.

In some embodiments, portable power source 230 may include a generator. The generator may be gasoline powered, or may be powered by other fuels such as diesel, bio-diesel, kerosene, propane, natural gas, or other suitable fuel. portable power source 230 may have a storage tank (not shown) for storing fuel and may be refilled.

In some embodiments, portable power source 230 may include one or more solar panels. Solar panels may be used to provide power directly to UAV 210 through tether 220. Solar panels may also be used to recharge batteries included in portable power source 230. Solar panels may also be used to supplement power from a generator.

As described above, in some embodiments, portable power source 230 may include an area on which UAV 210 may land. For example, FIG. 2 may illustrate a UAV 210 after it has landed on a landing surface of portable power source 230. In some embodiments, UAV 210 may automatically land on a surface of portable power source 230. For example, an operator may fly UAV 210 for a length of time, after which the operator enters a command causing UAV 210 to determine its location and/or distance to portable power source 230. Next, UAV 210 may move to and land on a surface of portable power source 230. In another example, UAV 210 may automatically land in response to a determination that its batteries (whether onboard or in portable power source 230) store less than a threshold amount of power. For example, after power source 230 is storing less than 10% of the maximum amount of power it can store, power source 230 may send signals to UAV 210 causing UAV 210 to land. In some embodiments, a command causing UAV 210 to land may be sent in response to a combination of an amount of power in portable power source 230, and a distance between portable power source 230 and UAV 210. For example, if UAV 210 is close to portable power source 230 (e.g., within 20 meters), it may receive a command to land if the power in portable power source 230 is less than a certain amount (e.g., 10%). On the other hand, in some embodiments, if UAV 210 is farther away from power source 230 (e.g., farther than 40 meters), it may receive a command to land if the power in portable power source 230 is less than a higher amount (e.g., 20%).

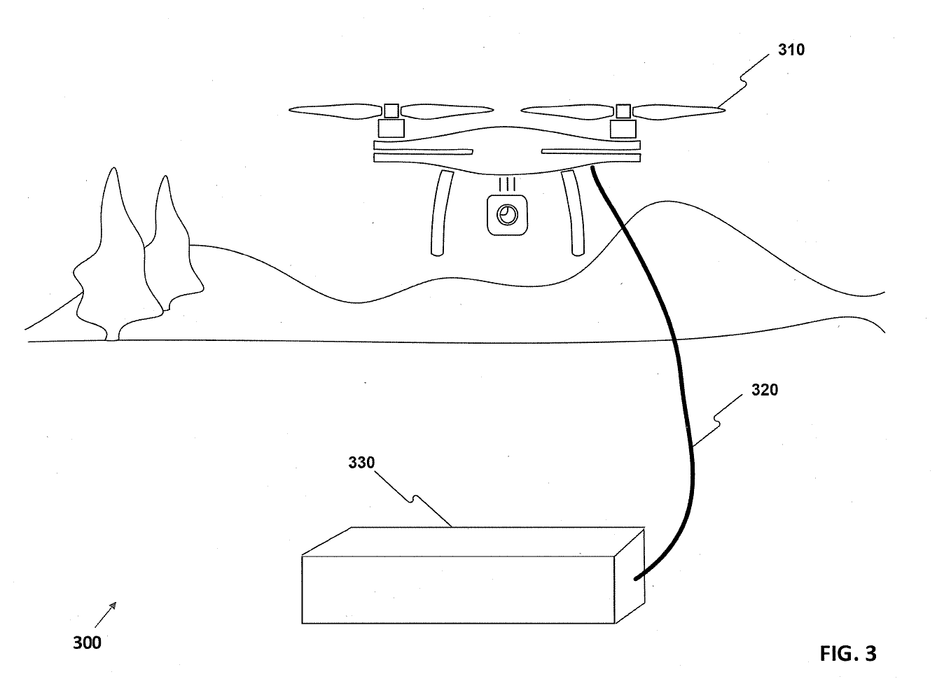

FIG. 3 illustrates an exemplary UAS 300 having a portable power source and a tether according to some embodiments of the present disclosure. As shown in FIG. 3, for example, UAV 310 may fly while being connected to portable power source 330 via tether 320.

In some embodiments, tether 320 may be configured to extend or retract into portable power source 330. Such extension or retraction may be caused by a remote control or UAV 310 flying away or toward portable power source 330. In some embodiments, a desired amount of tension on tether 310 may be set. For example, an operator may wish tether 310 to have a particular amount of slack. An operator may increase, decrease, or enter a particular amount of tension using a remote control. In some embodiments, a desired amount of tension on tether 310 may be predetermined (e.g., programmed into a memory included in UAV 310 or portable power source 310). For example, a preprogrammed amount of tension may be based on certain conditions either detected by a sensor included in UAV 310 or portable power source 330. In some embodiments, certain tensions could be based on events and/or conditions. For example, profiles may be created for various events and/or conditions such that a UAS behaves in a particular manner based on that profile (e.g., due to a threshold amount of wind, tension on a tether may be substantially greater than when wind is less than the threshold).

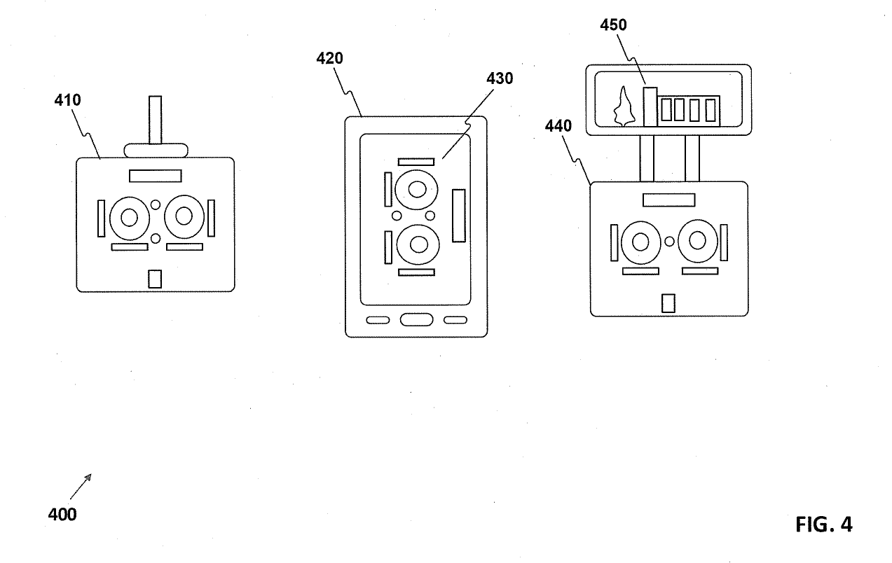

FIG. 4 illustrates exemplary remote controls 400 according to some embodiments of the present disclosure. As shown in FIG. 4, for example, remote controls 410, 420, and 440 may control functionality of a UAS. For example, remote control 410 may include two joysticks (one for moving a UAV forward, backward, left, or right, and another for moving a UAV up or down and rotating the UAV left or right). In addition, an example remote control 410 may include switches to control the trim of a joystick above and below each joystick. Trim may apply a small constant offset to a control in order to make an aircraft fly correctly. For example, if a UAV veers to the left when in flight, the trim switch below the left joystick may be moved to the right such that the UAV is stable when an operator is not touching the joysticks.

FIG. 4 also illustrates an example remote control 420, which includes an electronic device with a display 430 (e.g., a user interface). Example remote control 420 can be configured to have a variety of controls, since the controls are shown on display 430. Example remote control 420 may be a personal digital assistant, a smart phone, a tablet, a smart watch, a laptop, or other devices with display 430. In some embodiments, display 430 may be configured to show a joystick in one mode, and the view from a camera connected to a UAV in another mode. In various embodiments other modes may be available, which may allow an operator to command a UAV to land, tighten the slack on a tether, enter a message to send via a display or speaker, etc. Of course, display 430 may be a touch display that allows an operator to move virtual joysticks, etc.

FIG. 4 also illustrates a remote control 440 that includes a physical remote control and a display 450. Similar to remote control 420, display 450 included in (and/or connected to) remote control 440 may be a touch screen, and allow an operator to enter various commands to control a UAV and/or its connected components. In some embodiments, the joysticks included in remote control 440 may allow an operator to control the flight of a UAV, while display 450 may simultaneously display the view from a camera connected to the UAV. In some embodiments, remote control 420 and/or display 450 may be used to determine the position at which a camera is capturing images or film. Similarly, remote control 440 and/or display 450 may be configured to allow an operator to aim a hose or a light.

In some examples, controllers 410, 420, and 440 are configured to transmit one or more commands to the UAV. The one or more commands may instruct the UAV to perform inspect power lines, return to a platform, intercept an intruder, perform maintenance, etc.

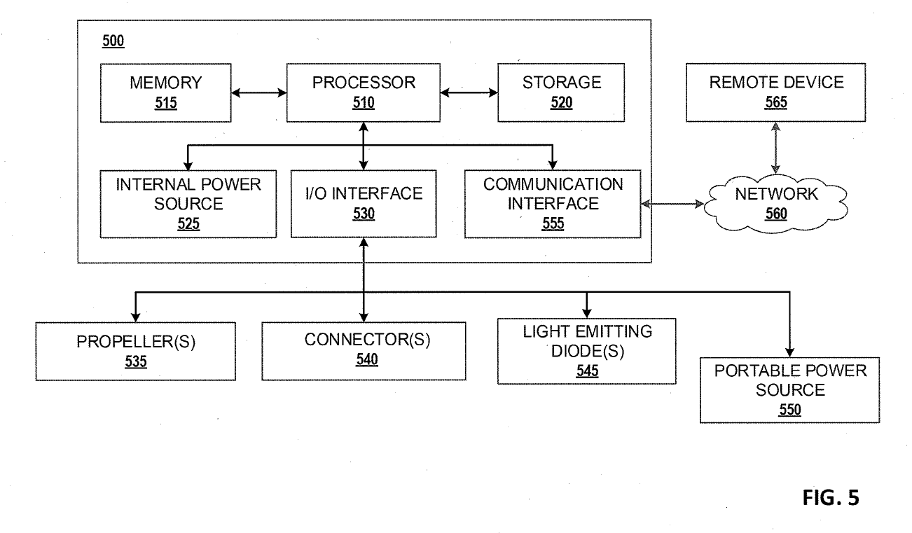

FIG. 5 illustrates a block diagram of an exemplary UAS according to some embodiments of the present disclosure. As illustrated in FIG. 5, a UAS may include an example internal system 500, and external components including one or more propellers 535, one or more connectors 540, one or more light emitting diodes (LEDs) 545, and a portable power source 550. FIG. 5 also shows a network 560 and a remote device 565.

Example internal system 500 may have, among other things, a processor 510, memory 515, storage 520, an input/output (I/O) interface 530, and/or a communication interface 555. At least some of these components may be configured to transfer data and send or receive instructions between or among each other. Processor 510 may be configured to receive signals from the components shown in FIG. 5, and process the signals to determine one or more conditions of the operations of system a UAS. For example, processor 510 may receive signals indicating that the wind is likely causing the UAV to be unstable, and use one or more components including propellers 535 to adjust the UAV to stabilize accordingly. Processor 510 may also be configured to generate and transmit a control signal in order to actuate one or more components. For example, processor 510 may detect a signal from portable power source 550 commanding the UAV to land due to lack of power. In response, processor 510 may cause the propellers to operate in such a manner that the UAV returns to portable power source 550 and lands either on or near portable power source 550.

In operation, according to some embodiments, processor 510 may execute computer instructions (program code) stored in memory 515 and/or storage 520, and may perform exemplary functions in accordance with techniques described in this disclosure. Processor 510 may include or be part of one or more processing devices, such as, for example, a microprocessor. Processor 510 may include any type of a single or multi-core processor, a microcontroller, a central processing unit, a graphics processing unit, etc.

Memory 515 and/or storage 520 may include any appropriate type of storage provided to store any type of information that processor 510 may use for operation. Memory 515 and storage 520 may be a volatile or non-volatile, magnetic, semiconductor, tape, optical, removable, non-removable, or other type of storage device or tangible (i.e., non-transitory) computer-readable medium including, but not limited to, a ROM, a flash memory, a dynamic RAM, and a static RAM. Memory 515 and/or storage 520 may also be viewed as what is more generally referred to as a “computer program product” having executable computer instructions (program codes) as described herein. Memory 515 and/or storage 520 may be configured to store one or more computer programs that may be executed by processor 510 to perform exemplary functions disclosed in this application. Memory 515 and/or storage 520 may be further configured to store data used by processor 510.

I/O interface 530 may be configured to facilitate the communication between example internal system 500 and other components of a UAS. I/O interface 530 may also receive signals from portable power source 550, and send the signals to processor 510 for further processing. I/O interface 530 may also receive one or more control signals from processor 510, and send the signals to control the operations of one or more propellers 535, one or more connectors 540, and/or one or more LEDs 545. As discussed below in greater detail, processor 510 may receive input from one or more components connected to a UAV via I/O interface 530 and one or more connectors 540. Various devices including sensors, or a lab on a chip, for example, may be connected to a UAS via one or more connectors 540 and configured to transmit data to processor 510.

Communication interface 555 may be configured to transmit and receive data with one or more remote devices 565 over network 560. In some embodiments, network 560 may include a cellular network, the Internet, a WiFi connection, a local area network, etc. In some embodiments, remote device 565 may be a remote control as described in FIG. 4. In some embodiments, remote device 565 may be cloud storage, a monitoring system, a remote computer, etc. In one example, communication interface 555 may be configured to receive from remote device 565 a signal indicative of moving a UAV forward or backward. As another example, communication interface 555 may be configured to receive from remote device 565 a signal indicative of controlling a camera connected to a UAV via connector 540 (e.g., remote device 565 may have a button that causes a camera connected to a UAV to capture an image). Communication interface 555 may also transmit signals to processor 510 for further processing.

In another example communication interface 555 may transmit data (e.g., images received through I/O interface 530, data processed by processor 510, data stored in storage 520 or memory 515, etc.) through network 560 to remote device 565. Data transmitted by communication interface 555 may be used, for example, to continuously monitor power lines while the UA is inspecting the power lines.

Remote device 565 (e.g., a remote control) may be any type of a general purpose computing device. For example, remote device 565 may include a smart phone with computing capacity, a tablet, a personal computer, a wearable device (e.g., Google Glass™ or smart watches, and/or affiliated components), or the like, or a combination thereof. In some embodiments, a plurality of remote devices 565 may be associated with one or more persons. For example, remote devices 565 may be associated with the owner(s) of a UAV, and/or one or more authorized people (e.g., employees or inspection personnel of the owner(s) of a UAV).

In some embodiments, a UAV may include an internal power source 525. Internal power source 525 may include batteries or cells, similar to portable power source 550. Power provided to a UAV may be acquired from either internal power source 525, portable power source 550, or a stationary power source (not shown), or any combination. In some embodiments, internal power source may include rechargeable batteries or cells that may be charged via portable power source 550 or one or more solar panels (not shown). In some embodiments, a UAV may acquire some or all of its power from internal power source 525 or portable power source 550 based on certain conditions. For example, if portable power source 550 contains less than a threshold amount of power, a UAV may stop acquiring power from portable power source 550 and instead acquire power from internal power source 525. Similarly, in some embodiments a UAV may use internal power source 525 for power until internal power source 525 contains less than a threshold amount of power, at which point the UAV switches to using power from portable power source 550. Other embodiments are also contemplated. For example, a remote control may allow an operator to cause a UAV to switch between acquiring power from internal power source 525 and portable power source 550. In some embodiments, if a tether is disconnected from a UAV, the UAV may automatically begin acquiring power from internal power source 525 instead of portable power source 550.

In some embodiments, one or more propellers 535 may be configured to cause a UAV to move in one or more directions, as described above. For example, a UAV may comprise four propellers 535 wherein two rotate in a clockwise direction and two rotate in a counterclockwise direction. In such an embodiment, propellers 535 may be fixed. It should be appreciated that in some embodiments, such as where a UAV comprises a single propeller similar to a conventional helicopter, the pitch of propeller(s) 535 may be controlled by processor 510. Similarly, although not shown in FIG. 5, the flaps or ailerons of a fixed wing UAV may be controlled by processor 510 and one or more actuators (not shown).

In some embodiments, one or more connectors 540 may be coupled to I/O interface 530 (or may be included in I/O interface 530) and may be configured to attach to various external components. As described below in greater detail, a connector may be used to connect various devices such as a camera, a light, a robotic arm, an inspection module, etc. In some embodiments, a plurality of connectors 540 allow a plurality of devices to attach to a UAV (e.g., a camera and a light). In some embodiments, connector 540 may transfer data to processor 510 and/or remote device 565, and/or allow remote device 565 to control a component attached to connector 540.

In some embodiments, LEDs 545 may be included in and/or connected to a UAV system. For example, a UAV may comprise red and green LEDs 545 configured to indicate which direction a UAV is facing. A UAV may also comprise LEDs 545 that are configured to indicate other conditions such as levels of oxygen at certain altitudes, or an amount of moisture in the atmosphere, for example. In some embodiments, a UAV may comprise programmable LEDs 545. For example, a user may be able cause LEDs 545 to show a particular symbol (e.g., based on the user and/or remote device 565 controlling a UAV). LEDs 545 may also be configured to display a company's logo, or other information associated with a company. In some embodiments, it is contemplated that a tether may include LEDs 545. For example, a UAV may fly at night and its location would be visible based on a tether illuminated by LEDs 545. It is further contemplated that in some embodiments, LEDs 545, or a speaker (not shown), may project a message. For example, an operator may want to provide a message to someone on a power pole, and LEDs 545 or a speaker included in a UAV may convey a message.

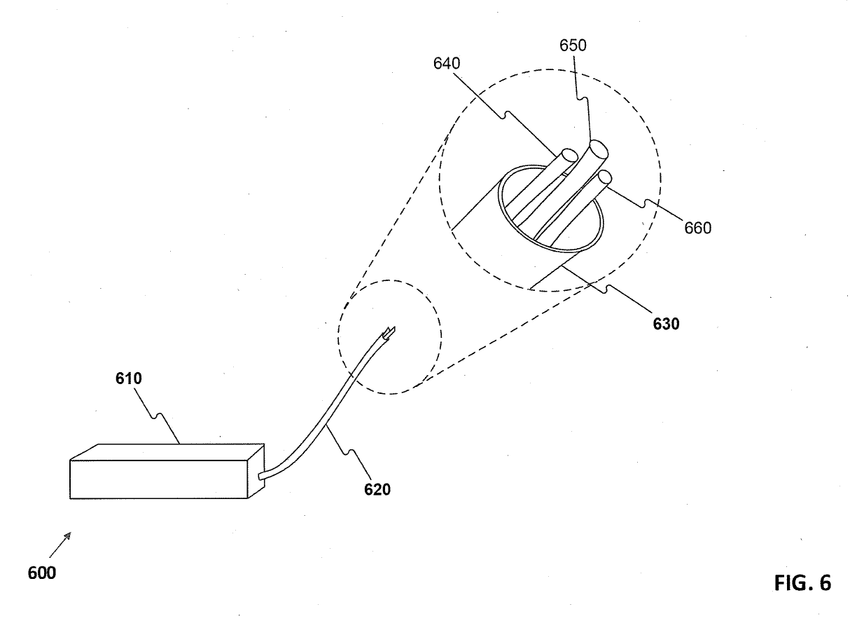

FIG. 6 illustrates an exemplary portable power source and tether 600 according to some embodiments of the present disclosure. As shown in FIG. 6, for example, portable power source 610 may include and/or be attached to a tether 620. Tether 620 may include a sheath 630 enclosing various cables 640, 650, and 660. In some embodiments, portable power source 610 may include a device that causes tether 620 to extend further out of portable power source 610, or retract into portable power source 610. In some embodiments, a command may be sent to portable power source 610 from a UAV or a remote control, wirelessly or otherwise, causing portable power source 610 to retract tether 620. In some embodiments, as described above, tether 620 may be configured to have a desired amount of tension. For example, a program stored in a memory of a UAV, a remote control, or portable power source 610 may indicate an amount of desired tension, and cause portable power source 610 to retract tether 620 to have a substantially desired amount of tension.

In some embodiments, the cables 640, 650, and 660 included in sheath 630 may transmit power and/or data. For example, cables 640 and 660 may transmit data to and/or from a UAV, while cable 650 may transmit power. In some embodiments, cables 640, 650, and/or 660 may be designated for particular purposes. For example, a cable 640 configured to send and/or receive data may send or receive data associated with power conditions in portable power source 610, while another cable 660 may send or receive data associated with power conditions in an internal power source of a UAV.

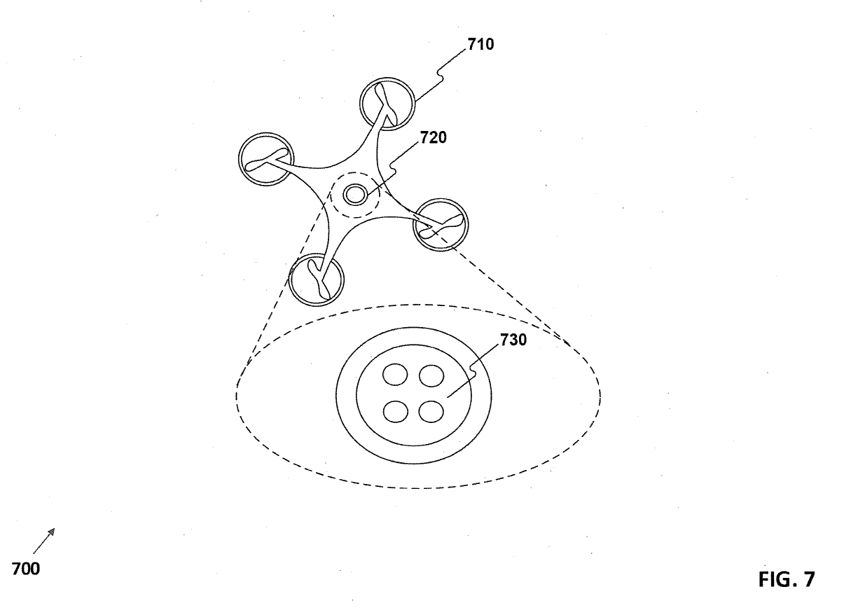

FIG. 7 illustrates an exemplary unmanned aerial system 700 having a connector according to some embodiments of the present disclosure. As shown in FIG. 7, connector 720 is located on a bottom side (e.g., a side facing the ground during normal flight) of UAV 710. In various embodiments, connector 720 may contain male and/or female connections 730 as shown within connector 720. In some embodiments, more than one connector may be included in UAV 710. Further, in some embodiment, more than one component may be attached to connector 720. For example, two or three connectors may be included in a UAV and two or three components may be attached to a UAV via one, two, or three connectors.

For example, one or more cameras may be attached to connector 720. In addition to cameras, or in the alternative, inspection equipment modules may be attached to connector 720 and include, but are not limited to: a light, a robotic arm, one or more sensors (e.g., electrical conductivity sensors, electrical current sensors, oxygen sensors, carbon dioxide sensors, carbon monoxide sensors, particulate sensors, motion sensors, accelerometers, gyroscopes, microphones, etc.), a display screen, a speaker, etc.

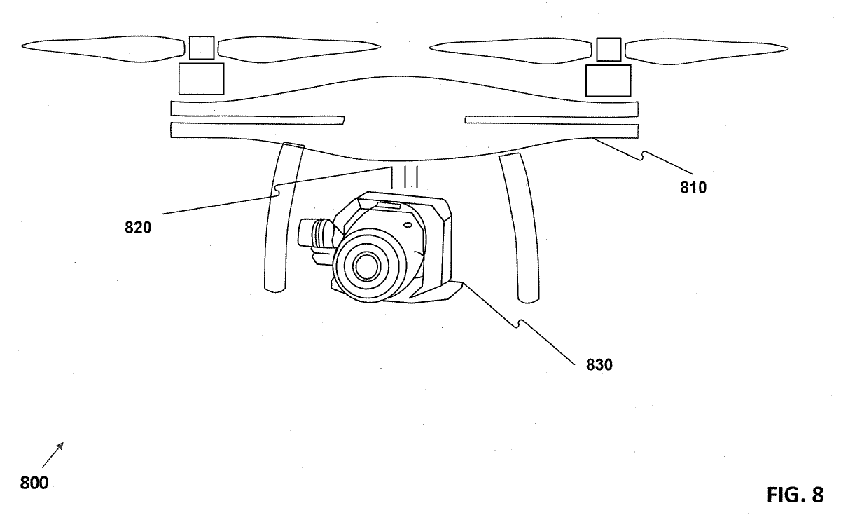

FIG. 8 illustrates an exemplary unmanned aerial system 800 having a camera according to some embodiments of the present disclosure. As shown in FIG. 8, for example, UAV 810 is connected to camera 830 via connector 820. In some embodiments, UAV 810 may be connected to multiple cameras 830 or other components. For example, UAV 810 may be configured to capture images or video associated with power line inspection. The UAV may be programmed to fly in a bounded area determined by the power line location. In another example, UAV 810 may be configured to capture images or video associated with damage to a property, or any other event occurring at the location. In some embodiments, UAV 810 may fly in a pattern based on one or more images or video captured by camera 830. For example, UAV 810 may determine its distance from an object based on one or more images or video captured by camera 830. Based on the distance, UAV 810 may fly closer to, or further away from the object. In some embodiments, camera 830 may be configured to capture three-dimensional images. In such embodiments, the images may be transferred to a computer and used to create a three dimensional object (e.g., printed with an additive manufacturing device, or 3D printer).

In some embodiments, a UAS 800 may be programmed to capture one or more images or video of a particular object or person. For example, recognition software (such as facial recognition) may allow a UAS 800 to identify a person or object, and then cause UAV 810 to position itself and/or camera 830 at a certain angle and location to capture images or video of the person or object. For example, camera 830 may be used to identify a particular fault in a power line, and then UAV 810 may be caused to fly closer to that fault (e.g., to verify the presence of the fault).

In some embodiments, camera 830 may be configured to capture images or video including a remote control used to control UAV 810. For example, an operator with a remote control may be inspecting power lines, and UAV 810 may be programmed to hover around remote control (e.g., the operator as he moves around the area with the power lines) at a particular height and/or particular distance. In such an example, camera 830 may be configured to capture images or video of a remote control (and/or the operator) as it hovers around the power lines. It should be appreciated that, instead of a remote control, a camera may be configured to capture images or video of another electronic device, a person based on facial recognition, or a particular location (e.g., a latitude and longitude). Further, it should be appreciated that in embodiments described herein, a camera may be configured to receive an input that causes it to change the angle it is aimed (e.g., the direction that a lens of a camera is facing).

In some embodiments, camera 830 may be a high resolution camera, such as a digital single-lens reflex (DLSR) camera. Camera 830 may be configured to acquire video or still images, and image resolution may be configurable. Camera 830 may include one or more lenses. For example, telephoto lenses may be used to acquire images from long distance, whereas macro lenses may be used to acquire images from close range. Any number of lenses may be used with camera 830.

In some embodiments, camera 830 may be able to collect images in the dark employing technology such as forward looking infrared (FLIR), starlight, etc. Camera 830 may be used to track individuals or inspect property. For example, camera 830 may be used to detect gas leaks, overheating equipment, fires, water leakage, etc.

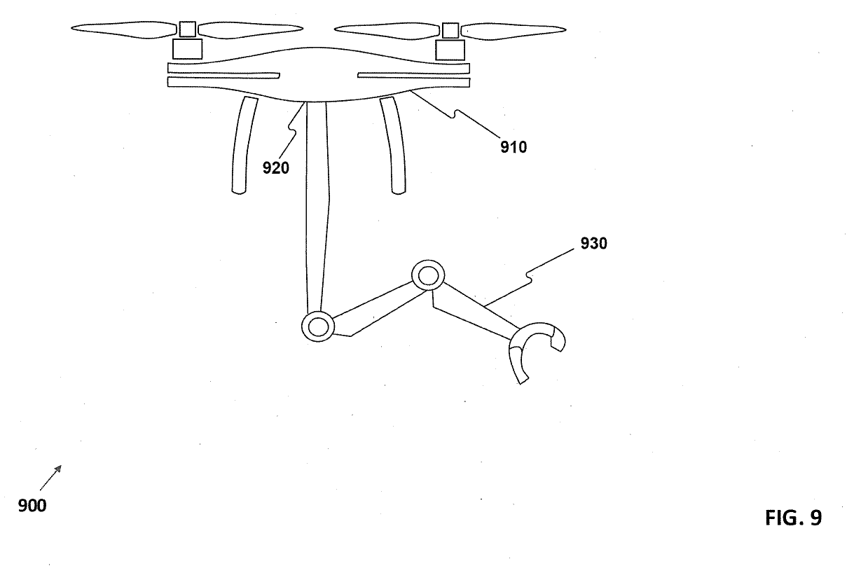

FIG. 9 illustrates an exemplary unmanned aerial system 900 having a robotic arm according to some embodiments of the present disclosure. As shown in FIG. 9, for example, UAV 910 is connected to a robotic arm 930 via connector 920. Robotic arm 930 may be configured to perform a variety of actions, including, but not limited to: rescuing a person (e.g., from becoming stuck on a power pole), acquiring an animal (e.g., a cat on a power pole), acquiring test equipment (e.g., test equipment left on a power pole), acquiring soil samples (e.g., to determine whether PCBs have leaked out of a transformer), acquiring water samples, moving objects (e.g., power lines attached to power poles), repairing power lines (e.g., fixing insulator elements that are damaged in a storm), etc.

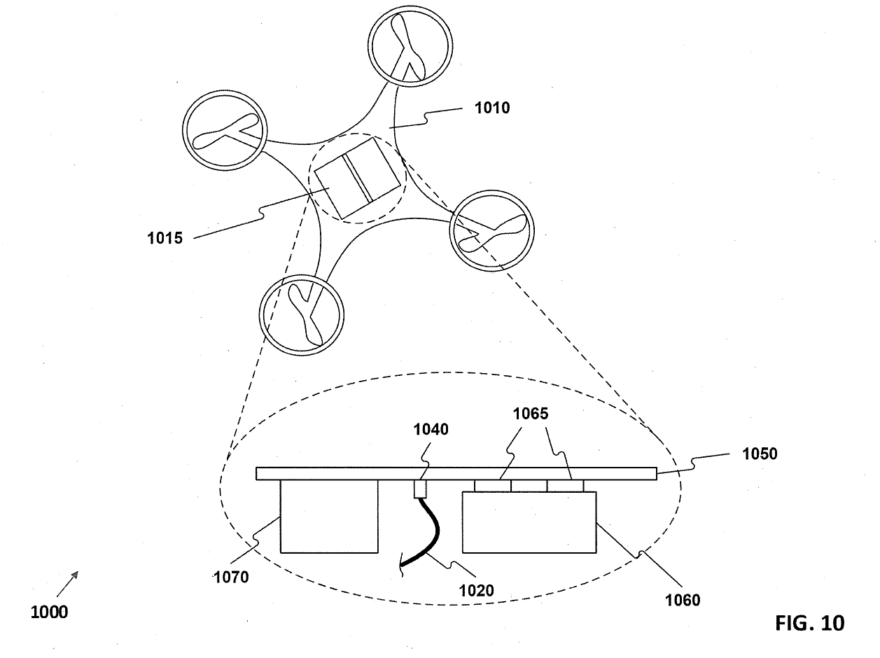

FIG. 10 illustrates an exemplary unmanned aerial system 1000 having quick-disconnect battery according to some embodiments of the present disclosure. As shown in FIG. 10, for example, UAV 1010 comprises a maintenance bay 1015 for access to internal components. Maintenance bay 1015 can be located anywhere on the fuselage of UAV 1010. In some examples, maintenance bay 1015 is located on the underside of UAV 1010. Connectors for external components may be integrated into the bay doors or be located adjacent to the maintenance bay 1015.

In some embodiments, opening maintenance bay 1015 exposes carrier 1050. Carrier 1050 comprises connections for attaching at least one of a tether 1020 to tether attachment point 1040 and a battery 1060 to disconnect points 1065. Battery 1060 may have charging connectors, in the alternative or in addition to disconnect points 1065. Carrier 1050 may also include internal electronics 1070, as described above with respect to FIG. 5. Carrier 1050 may comprise interconnections to route power and data to and from internal electronics 1070 to tether 1020 and/or battery 1060.

In some embodiments, UAV 1010 may land on a landing platform and open maintenance bay 1015. UAS 1000 may then automatically charge and/or swap battery 1060, if present.

In some embodiments, the UAS comprising a UAV may be configured to carry one or more objects, people, and/or animals. Various UAVs described herein may be configured to produce an amount of lift sufficient to carry objects, people, and/or animals. A portable power source may be physically connected to a tether capable of transmitting power and data, which may in turn be connected to a UAV. In some embodiments, a portable power source may comprise one or more batteries or other components that acquire, store, and/or transmit power to a UAV. The portable power source may be a stand-alone device, and small enough to be transported in an automobile. The power source may be removed from a vehicle, activated, and connected to a UAV to power it for longer periods of time than a battery within the UAV itself.

In some embodiments, the UAV may include a connector that allows external components to attach to the UAV. A connector may be configured to allow a UAV to carry external components such as a objects, people, and/or robotic arms. External components may include large items used for a variety of purposes. For example, external components may include a rope, landscaping equipment, painting equipment, etc. External components may be used to carry a person, or perform tasks such as painting, landscaping, cleaning, lifting objects, people, and/or animals, etc.

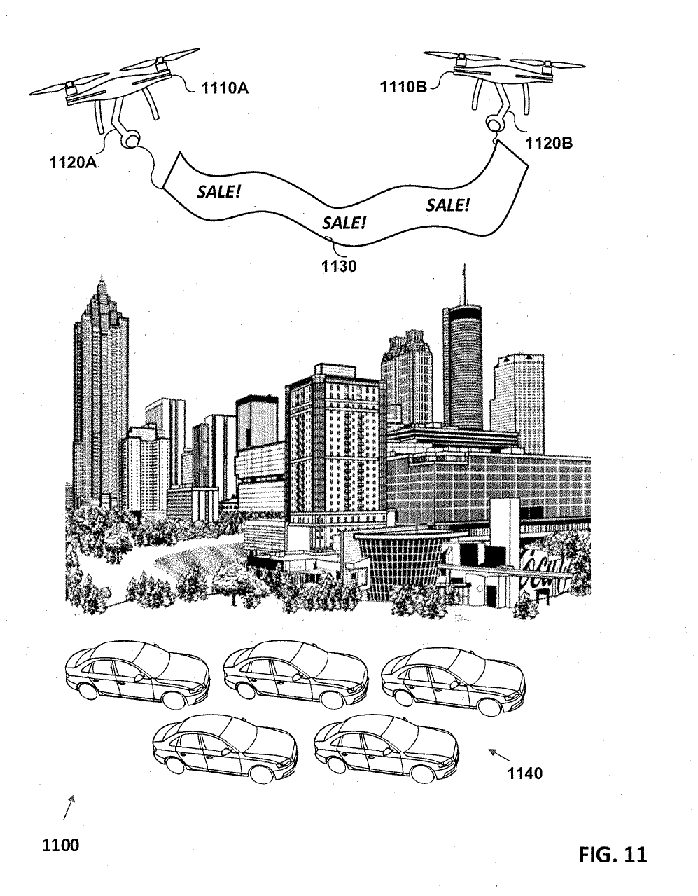

FIG. 11 illustrates an exemplary environment 1100 including a UAV 1110 and an advertising banner 1130 according to some embodiments of the present disclosure. As shown in FIG. 11, for example, UAVs 1110A and 1110B have robotic arms 1120A and 1120B attached to connectors on the UAVs, respectively. Robotic arms 1120A and 1120B may hold cables connected to an advertising banner 1130.

In some examples, advertising banner 1130 may advertise a sales event in a location or at a particular establishment. For example, cars 1140 may be at a car dealership and UAVs 1110A and 1110B may fly above the dealership with advertising banner 1130. Alternatively, the UAVs may fly throughout a city advertising the sale.

In some embodiments, a sales event (e.g., car auction, etc.) may occur away from a city or in a remote area. In this case the UAVs may be powered by a portable power source. In some embodiments, the UAVs may be configured to fly from a predetermined area (e.g., the city) to the remote location to attract more customers.

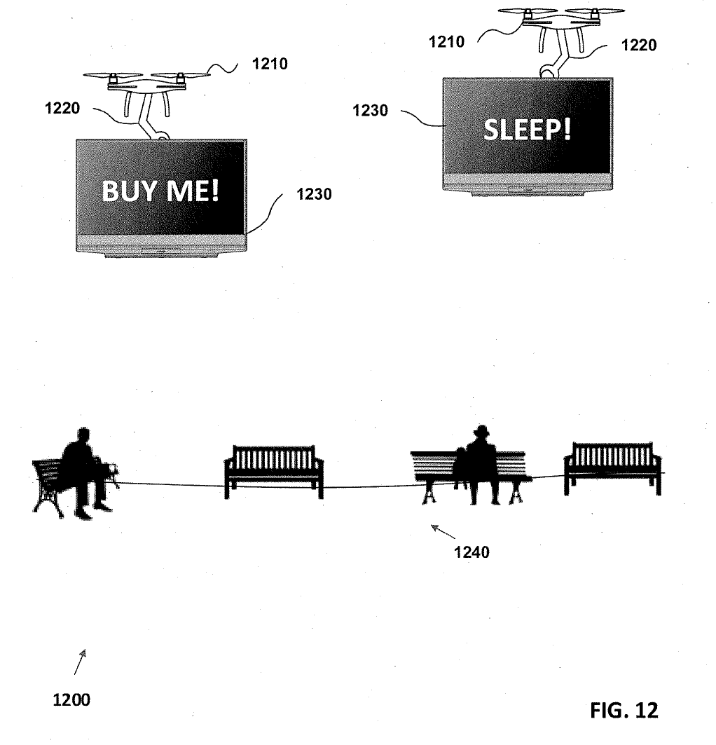

FIG. 12 illustrates an exemplary environment 1200 including UAVs 1210 and display screens 1230 for advertising according to some embodiments of the present disclosure. As shown in FIG. 12, for example, UAVs 1210 have robotic arms 1220 attached to connectors on the UAVs, respectively. Robotic arms 1220 may hold display screens 1230.

In some embodiments, display screen 1230 may be held by robotic arm 1220. In other embodiments, display screen 1230 may be directly connected to UAV 1210 or may be connected by some other means.

In some embodiments, UAVs 1210 may carry the display screens 1230 and fly over a park or other area to advertise a product or display a message. In some examples, display screens 1230 may be LED screens, LCD screens, plasma screens, rear projection screens, or any other self-contained display screen technology. In some embodiments, UAV 1210 may be connected to display screen 1230 through a connector and I/O port to transmit data to the display screen 1230. Display screen 1230 may receive the data and display a message according to the data. In some examples, UAV 1210 may have messages stored in memory and display the messages on the display screen 1230 when certain conditions occur. For example, UAV 1210 may also include a camera and use image recognition software to recognize events or people 1240. When a certain event or person 1240 is recognized, UAV 1210 may transmit data to the display screen 1230 to display a particular message (e.g., “buy me”) that is targeted to the particular person or event 1240. In other embodiments, an operator may use a controller or other remote device to command UAV 1210 to display a certain message on display screen 1230.

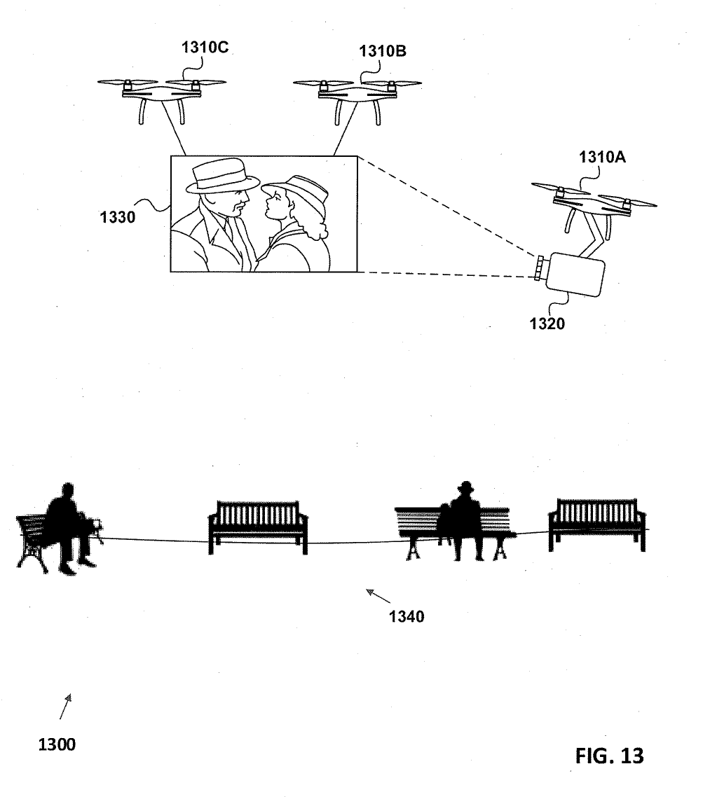

FIG. 13 illustrates an exemplary environment 1300 including UAVs 1310 and a projector 1320 and screen 1330 according to some embodiments of the present disclosure. As shown in FIG. 13, for example, UAV 1310A is connected to projector 1320 and UAVs 1310B, 1310C are connected to screen 1330. UAV 1310A may position itself to project a scene onto screen 1330 from a certain distance away (e.g., far enough to fill the screen with an image).

In some embodiments, screen 1330 may be not be used. Instead UAV 1310A may position itself to project a scene from projector 1320 onto an existing stationary object and/or a moving object. For example, projector 1320 may project a scene onto a building, truck, tree, the ground, etc.

In some examples, the projected scene may be a movie trailer and displayed in a park 1340. The movie trailer may entice people in the park 1340 to go see the movie. The same movie trailer may be displayed in multiple locations by programming and/or commanding the UAVs to fly to other locations.

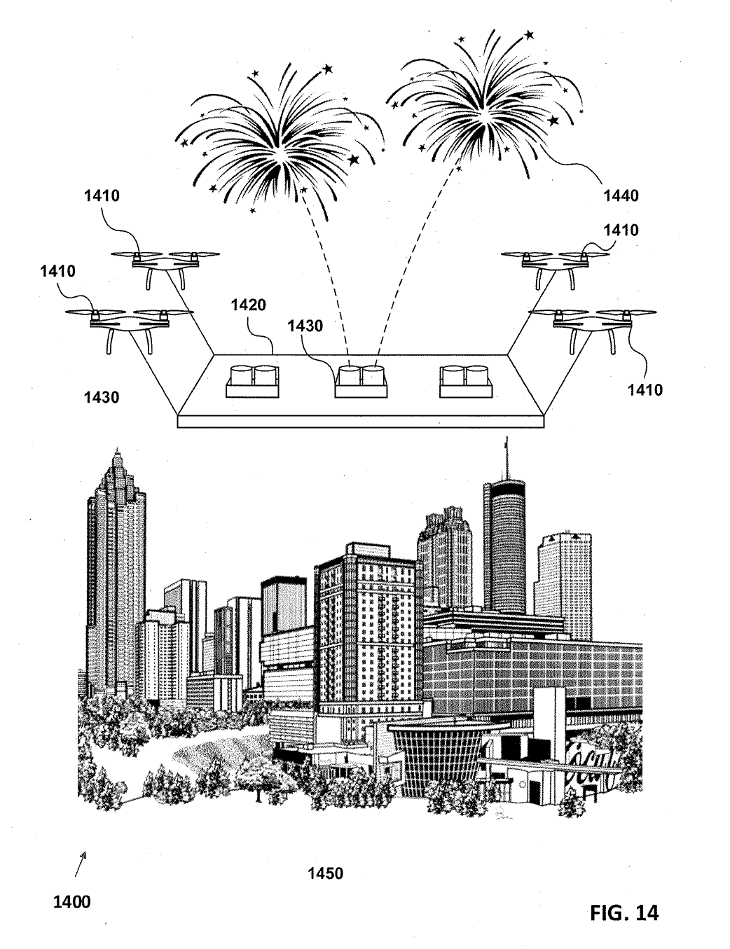

FIG. 14 illustrates an exemplary environment 1400 including UAVs 1410 and a fireworks launching pad 1420 according to some embodiments of the present disclosure. As shown in FIG. 14, for example, UAVs 1410 are connected to a fireworks launching pad 1420 by cables. Fireworks launching pad 1420 may include one or more fireworks containers 1430 used to launch fireworks 1440.

In some embodiments, UAVs 1410 may be used to launch fireworks 1440 from a location where launching fireworks 1440 would otherwise be unfeasible. For example, due to safety concerns or weather problems, a proper ground-based fireworks platform installation may not be possible. However, UAVs 1410 may be used to elevate the launching platform to allow the display to occur.

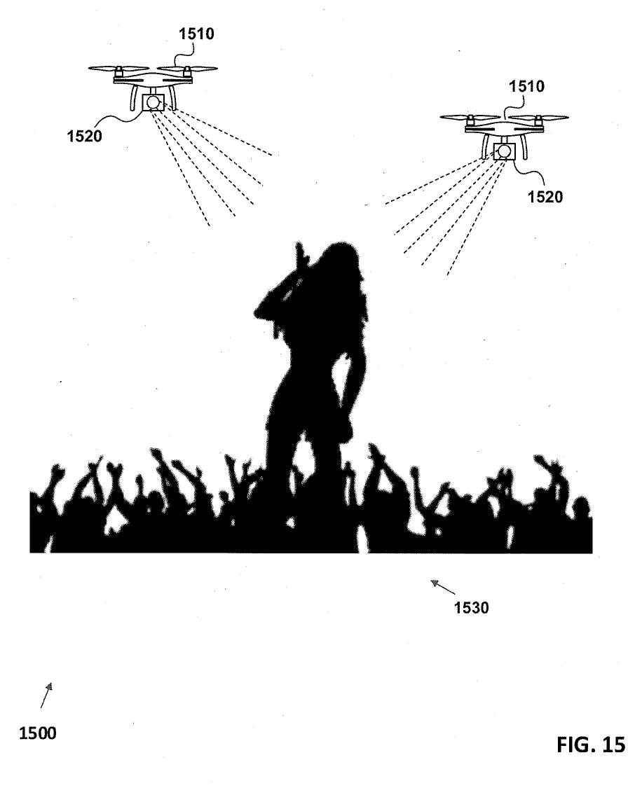

FIG. 15 illustrates an exemplary environment 1500 including UAVs 1510 and light projectors 1520 according to some embodiments of the present disclosure. As shown in FIG. 15, for example, UAVs 1510 are connected to light projectors 1520 and are configured to fly above an event 1530.

In some embodiments, event 1530 may be a concert, or other live event, and UAVs 1510 may be configured to shine spotlights on one or more performers. In other embodiments, UAVs 1510 may be configured to use light projectors 1520 to display advertisements. For example, light projectors 1520 may have filters that create a projected image or message. UAVs 1510 may position light projectors 1520 to display the image or message throughout the event 1530. In other embodiments, light projectors 1520 may be programmable. UAVs 1510 may transmit data to and program light projector 1520 to display a preprogrammed message or image.

In some embodiments, the UAV may include a connector that allows external components to attach to the UAV. A connector may be configured to allow a UAV to carry external components to supply individuals with recreational equipment needed during a recreational event, light-emitting equipment to aid the individual, and/or a display device that is capable of displaying scores, videos and other data. For example, external components may include a camera, flashlights, LCD screen, golf bag, drinks, or snacks. In some examples, the camera may be used to record recreational activities, assist individuals, etc.

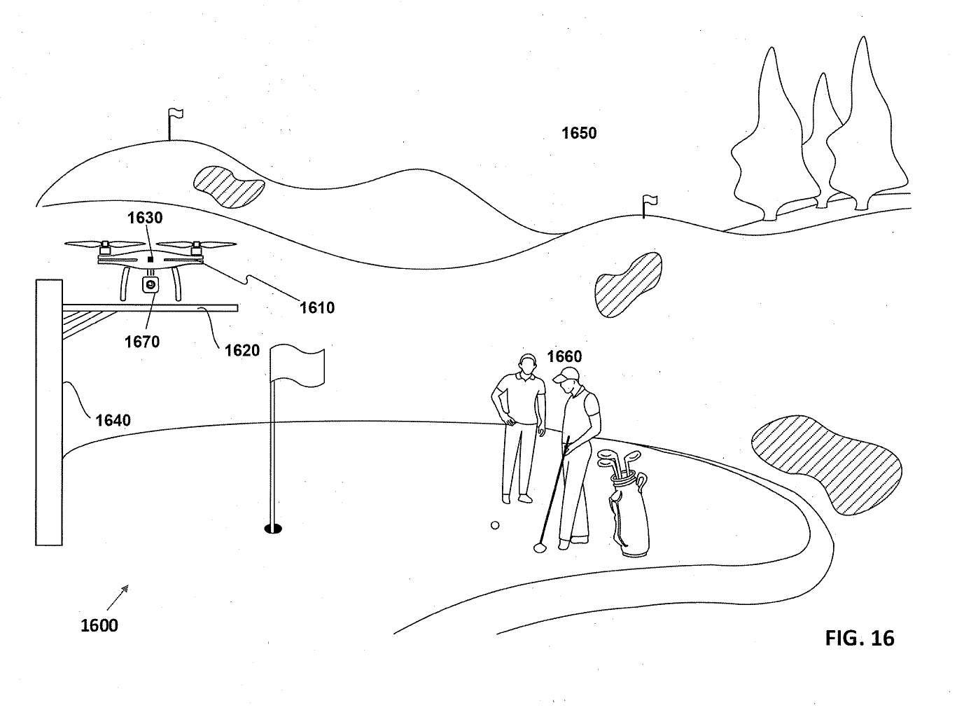

FIG. 16 illustrates an exemplary environment 1600 including an unmanned aerial vehicle 1610 and an elevated platform 1620 according to some embodiments of the present disclosure. As shown in FIG. 16, for example, UAV 1610 is sitting atop elevated platform 1620. In some embodiments, elevated platform 1620 may be permanently affixed to a structure such as pole 1640. In other embodiments, the platform may sit on the ground. Elevated platform 1620 may be connected to the electricity source. Elevated platform 1620 may then be used to power UAV 1610 by, for example, recharging internal UAV batteries, supplying power through a tether, maintaining charged batteries that can be swapped out with UAV 1610 internal batteries, etc.

In some examples, an elevated platform 1620 may be portable. For example, an operator may temporarily affix the platform to a ridged structure for temporary use. Elevated platform 1620 may use a local power source or a portable power source as described above. In some examples, a portable elevated platform 1620 may be used to surveil areas on a limited basis.

In the example, UAV 1610 may be tethered to elevated platform 1620 or use an internal power source. UAV 1610 may take off from elevated platform 1620 and fly around the golf course 1650 while capturing images and videos of the golf course 1650 and the individuals 1660 on the golf course. UAV 1610 may transmit the video to an operator or monitoring station. In practice, UAS 1600 may replace or enhance pan-tilt-zoom cameras that are fixed and mounted on or around the golf course 1650. The mobility of UAV 1610 may enhance surveillance of a recreational area that is not possible or as efficient with fixed camera placements.

In some examples, UAV 1610 may remain airborne indefinitely by using a tether to elevated platform 1620. UAV 1610 may be designed to operate in most weather conditions, however, if UAV 1610 needed to land, for example, in an electrical storm, UAV 1610 may return to elevated platform 1620. In some examples, elevated platform 1620 may include a cover to protect UAV 1610 from damage.

In some embodiments, elevated platform 1620 (e.g., a landing pad, hanger, other surface, etc.) may be included in the UAS. In some examples, the platform may house communications equipment that communicates with the UAV. For example, the platform may contain radiofrequency transmitters to communicate with the UAV wirelessly or through a tether. In other embodiments, the platform may be configured to provide a WiFi connection to the UAV.

In some embodiments, a sensor 1630 may be attached to UAV 1610. For example, sensor 1630 may be a proximity sensor, photoelectric sensor, etc.). In some examples, sensor 1630 may detect players approaching UAV 1610 and camera 1670 may automatically begin to record. In some embodiments, a sensor 1630 may detect weather conditions and communicate to UAV 1610 to inform players of the weather conditions. In another embodiment, a wireless network sensor system may include a set of sensors placed throughout a recreational event that function in conjunction with sensor 1630 to detect the presence and location of individuals 1660. The wireless network sensor system may transmit information to the UAV including boundaries of a recreational event, locations of a group of individuals, and a set of weather data.

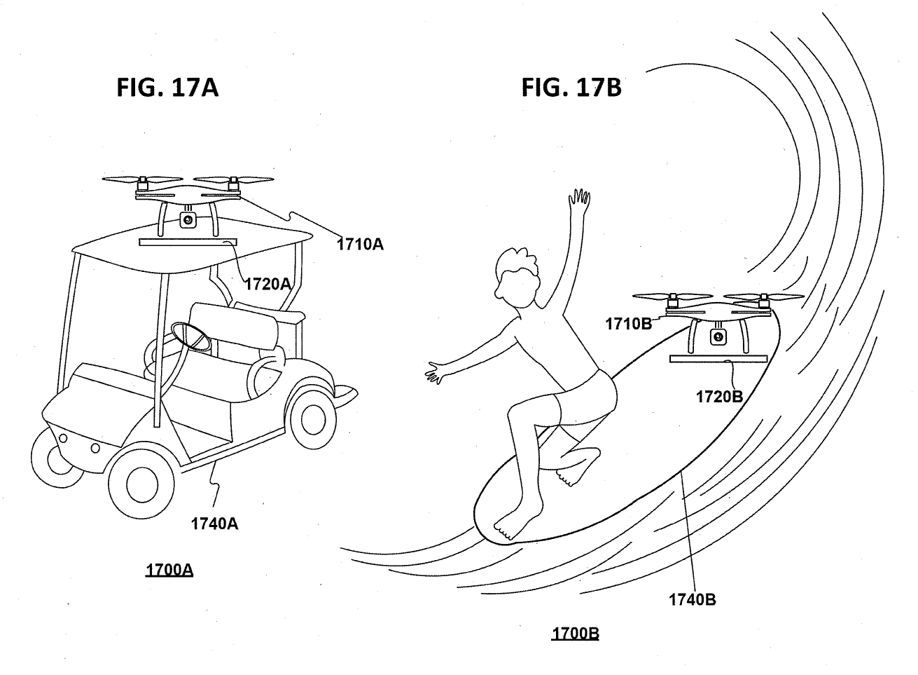

FIGS. 17A and 17B illustrate exemplary environments 1700A and 1700B including unmanned aerial vehicles 1710A and 1710B and portable platforms 1720A and 1720B according to some embodiments of the present disclosure. In some embodiments, portable platforms 1720A and 1720B are fixedly attached to recreational objects 1740A and 1740B. Portable platforms 1720A and 1720B may include a portable power source, as shown in FIG. 2. Portable platforms 1720A and 1720B may raise or lower, providing UAVs 1710A and 1710B, respectively, with protection from tampering. In some examples, portable platforms 1720A and 1720B may be stand-alone systems that are loaded and unloaded from a transport vehicle. In some embodiments, portable platform 1720A and 1720B may supply power to UAVs 1710A and 1710B, as described in earlier embodiments. In other examples, portable platform 1720A and 1720B may supply charged batteries that UAVs 1710A and 1710B may swap out automatically, as described in earlier embodiments. In other examples, portable platforms 1720A and 1720B may provide a charging connector that can be connected to UAVs 1710A and 1720B to charge internal batteries, as described in earlier embodiments.

In some embodiments, the platform (e.g., a landing area, other surface, landing pad, etc.) may be included in the UAS. In some examples, the platform may house communications equipment that communicates with the UAV. For example, the platform may contain radiofrequency transmitters to communicate with the UAV wirelessly or through a tether.

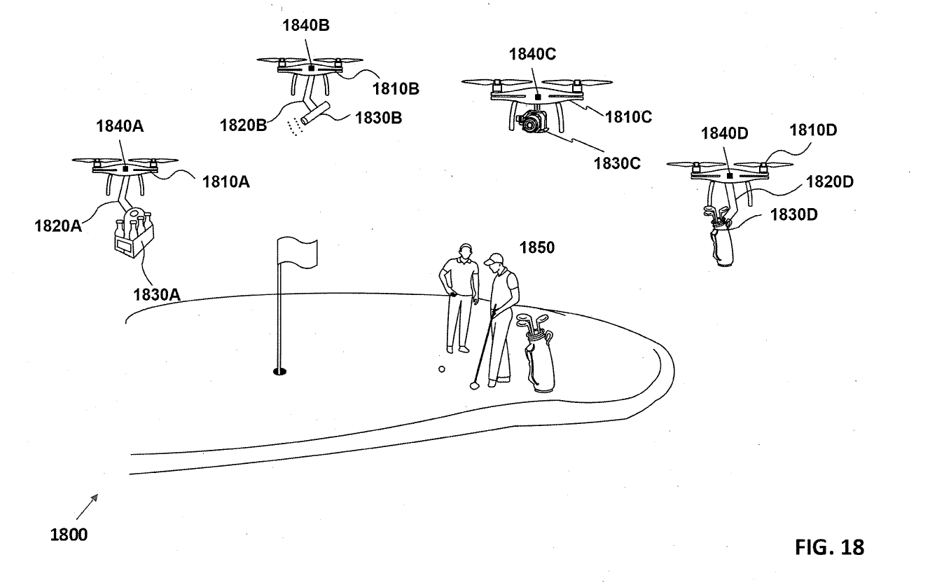

FIG. 18 illustrates an exemplary environment 1800 including an unmanned aerial vehicles (UAVs) 1810A, 1810B, 1810C, and 1810D, according to some embodiments of the present disclosure. As shown in FIG. 18, for example, robotic arms 1820A, 1820B, and 1820D are attached to UAVs 1810A, 1810B, and 1810D, respectively, and carry various recreational equipment, such as drink refreshments 1830A, light-emitting device 18308 (e.g., flashlight), and golf bag 1830D, to assist individuals during a recreational event (e.g., golf game).

In some embodiments, UAVs 1810A, 1810B, 1810C, and 1810D may track individuals 1850 throughout the recreational event using sensors 1840A, 1840B, 1840C, and 1840D, respectively. UAV 1810C may use camera 1830C to track individuals 1850 using machine vision. Individuals 1850 may communicate a task to a UAV including bringing a golf bag 1830D to the individuals 1850, going to the clubhouse to get refreshments 1830A and bringing them to the individuals 1850, and turning on a light-emitting device 1830B to increase the visibility conditions for the individuals 1850.

In some embodiments, UAV 1810C may observe the actions of individuals 1850 and their surroundings and alter its position to allow camera 1830C to capture clear and precise images or video of the recreational event or individuals 1850. For example, if individuals 1850 hit a golf ball towards a golf hole, the UAV 1810C may adjust its position to enable camera 1830C to capture images or video of the shot, the ball rolling to the hole, and/or the movements of the individuals 1850. In some embodiments, camera 1830C may stream captured images or video to a remote device, including a television screen in the clubhouse, a mobile device, or other networked devices (e.g., cloud computing resources).

In some examples, UAVs 1810A, 1810B, 1810C, and 1810D may need to return for maintenance, need to swap internal batteries, escape severe weather, etc. UAVs 1810A, 1810B, 1810C, and 1810D may then return to the golf course. UAVs 1810A, 1810B, 1810C, and 1810D may be programmed to automatically return to the golf course under certain conditions.

In some embodiments, the platform (e.g., a landing area, hanger, other surface, landing pad, etc.) may be included in the UAS. In some examples, the platform may house communications equipment that communicates with the UAV. For example, the platform may contain radiofrequency transmitters to communicate with the UAV wirelessly or through a tether.

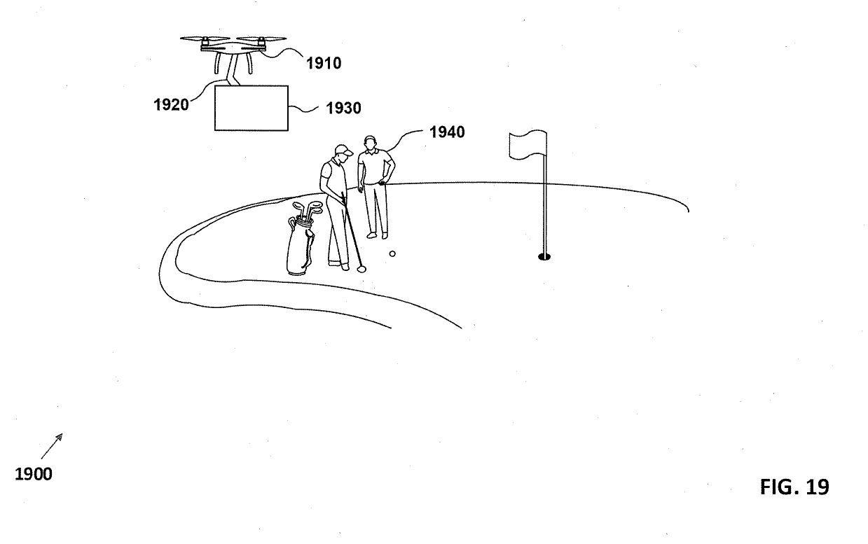

FIG. 19 illustrates an exemplary environment 1900 including an unmanned aerial vehicle (UAV) 1910, according to some embodiments of the present disclosure. In some embodiments, robotic arm 1920 may carry a display component 1930 that presents data related to a recreational event, including, but not limited to, a video stream of golf players, a scorecard, or any other data that the UAV 1910 captures. In some examples, the UAV 1910 analyzes movements of individuals and recreational equipment (e.g., golf ball, etc.) to calculate and display the score on display component 1930. In some embodiments, a UAV 1910 may include a camera to analyzes movements of individuals and recreational equipment (e.g., golf ball, etc.) to calculate and display the score on display component 1930. In some embodiments, a second UAV having a camera may transmit data indicative of the recreational event (e.g., scores, player profiles, tracking information, etc.) to UAV 1910 or may project onto display component 1930. For example, a second UAV may capture images or videos of other golfers, transmit the captured images or videos to UAV 1910, where display component 1930 displays the captured images or videos. In some examples, individuals 1940 may input scores on a remote device, such as a mobile phone, that communicates the score to a UAV 1910 and is displayed on display component 1930.

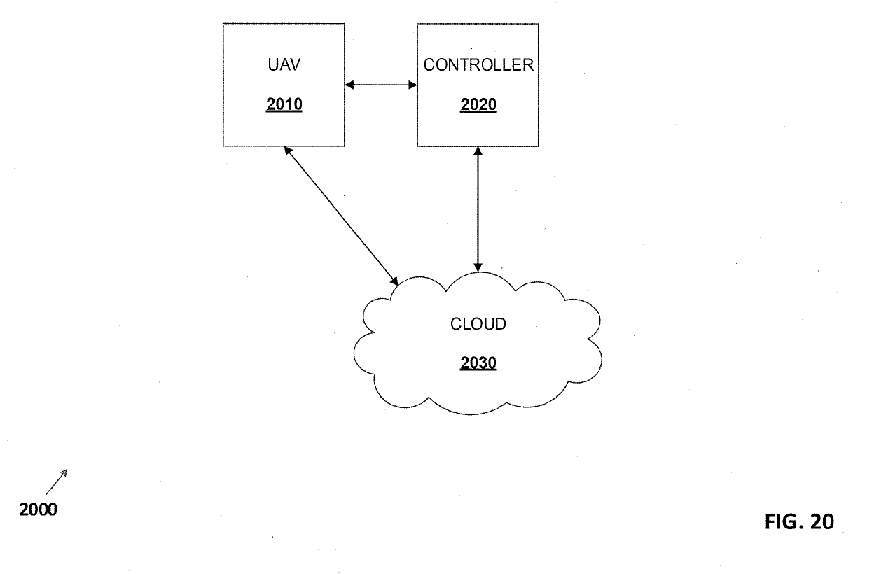

FIG. 20 illustrates an exemplary environment 2000 including an unmanned aerial vehicle (UAV) 2010 communicating with controller 2020 and cloud 2030, according to some embodiments of the present disclosure. As shown in FIG. 20, for example, UAV 2010 gathers data relating to a recreational event and transmits the data to a controller 2020 or a cloud component 2030. In some embodiments, the gathered data may be gathered by a camera attached to a UAV 2010, a sensor attached to a UAV 2010, or a wireless network sensor system as described in an above embodiment. The gathered data may include recordings of individuals at a recreational event, recordings of a recreational event, and/or a set of weather data. In some embodiments, the gathered data may include boundaries and configurations of the recreational event (e.g., a map of the golf course). In other embodiments, the UAV 2010 may track individuals using machine vision to determine a score for the event. In some embodiments, the controller 2020 may be a cell phone, PDA, tablet, laptop, or other computing device. Controller 2020 may communicate directly with UAV 2010 and/or cloud component 2030.

In some embodiments, the controller 2020 or cloud 2030 may aggregate the data gathered from a UAV 2010. In some embodiments, the controller 2020 or a cloud 2030 may transmit the aggregated data back to the UAV 2010 for display on a display component. The display component may include a networked device, monitor, and/or a projector. In some examples, the controller 2020 or a cloud 2030 transmits the aggregated data to a remote location to display. For example, the remote location may be a golf clubhouse and the aggregated data may be displayed on a networked device within the clubhouse. In some embodiments, the display component may display scores of individuals (in addition to the recreational event), video of individuals performing at a recreational event (e.g., playing golf), locations of individuals at a recreational event, and/or weather data at different locations of a recreational event. In some examples, the controller 2020 or cloud 2030 may aggregate the gathered data and generate one or more flight paths for the UAS to use. The flight paths may be based on boundaries and configurations of the recreational event, locations of individuals within a recreational event or other gathered data.

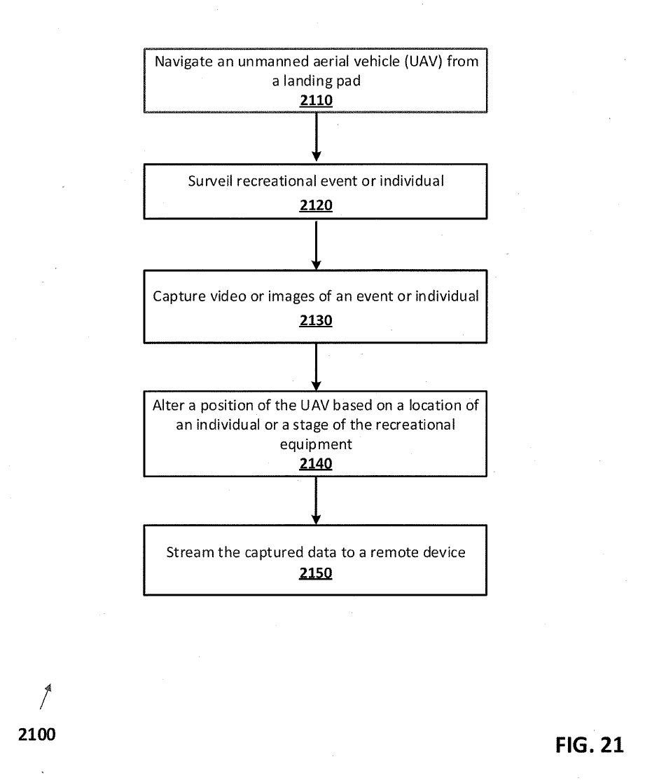

FIG. 21 is a flowchart of an exemplary method 2100 of surveilling recreational events or individuals by an unmanned aerial vehicle (UAV) and can be implemented for examine in a system as shown in the previous figures.

At step 2110, a UAV is navigated from a landing pad. In some embodiments, the UAV can be programmed to navigate autonomously. In other embodiments, an operator can manually navigate the UAV to a desired location. The landing pad may be affixed to a recreational vehicle (e.g., on top of a golf cart), at a specific recreational event location (e.g., golf hole), or at a remote location away from the recreational event (e.g., clubhouse).

At step 2120, the UAV surveils a recreational event or individual. In some embodiments, the UAV may be configured to surveil the recreational event or an individual at the event using, for example, a camera. In some examples, a UAV may receive a command to fetch recreational equipment, turn on an attached light component, or transmit weather conditions to a remote device. In some embodiments, a UAV may be configured to return to the portable landing pad after finishing surveillance. For example, if a recreational event is over or weather conditions are too dangerous for flight, the UAV may return to the portable landing pad.

At step 2130, a camera attached to the UAV captures video or images of the recreational event or individual. In some embodiments, the UAV may be configured to use machine vision to track an individual or a recreational equipment in the images (e.g., golf ball) and, based on these observed movements, determines a score for the recreational event. In some embodiments, the camera may automatically begin capturing video or images when a sensor attached to the UAV detects a specific recreational event or an individual approaching. In some examples, the camera may capture video and images of the boundaries and configurations of the recreational event (e.g., golf course) to be converted into fight paths for the UAV.

At step 2140, the UAV alters its position based on the observed actions during the recreational event. For example, on a golf course, the UAV would adjust its angle depending on where individuals are located and where the golf ball is being hit to and from.

At step 2150, the UAV transmits the captured image or video data to a remote device (e.g., cell phone, PDA, tablet, laptop, or other computing device). In some embodiments, the transmitted data includes a calculated score for the recreational event based on the machine vision tracking described above. In some examples, the remote device may be a display component that is connected to a UAV or a device located in a remote location (e.g., golf clubhouse).

The technologies described herein have many advantages in the field of unmanned aerial vehicles. For example, prolonged inspection of power lines in remote locations may be provided. UAVs may also quickly assess damage to and repair power lines without the need for intervention.

Aspects of the embodiments and any of the methods described herein can be performed by computer-executable instructions stored in one or more computer-readable media (storage or other tangible media) or stored in one or more compute readable storage devices, as described herein. The computer-executable instructions can be organized into one or more computer- executable components or modules. Aspects of the embodiments can be implemented with any number and organization of such components or modules. For example, aspects of the disclosed embodiments are not limited to the specific computer-executable instructions or the specific components or modules illustrated in the figures and described herein. Other embodiments may include different computer-executable instructions or components having more or less functionality than illustrated and described herein.

The order of execution or performance of the operations in the disclosed embodiments illustrated and described herein is not essential, unless otherwise specified. That is, the operations can be performed in any order, unless otherwise specified, and embodiments can include additional or fewer operations than those disclosed herein. For example, it is contemplated that executing or performing a particular operation before, contemporaneously with, or after another operation is within the scope of aspects of the disclosed embodiments.

Having described the disclosed embodiments in detail, it will be apparent that modifications and variations are possible without departing from the scope of aspects as defined in the appended claims. For instance, elements of the illustrated embodiments may be implemented in software and/or hardware. In addition, the technologies from any embodiment or example can be combined with the technologies described in any one or more of the other embodiments or examples. In view of the many possible embodiments to which the principles of the disclosed technology may be applied, it should be recognized that the illustrated embodiments are examples of the disclosed technology and should not be taken as a limitation on the scope of the disclosed technology. Therefore, it is intended that all matter contained in the above description and shown in the accompanying drawings shall be interpreted as illustrative and not in a limiting sense.

1. An unmanned aerial system (UAS), comprising:
an unmanned aerial vehicle (UAV); and
a carrying component.

2. The UAS of claim 1, wherein the carrying component is attached to the UAV.

3. The UAS of claim 1, wherein the UAV is attached to one or more display screens, the UAV is configured to transmit data to the one or more display screens , and the one or more display screens are configured to display a message based on the transmitted data.

4. The UAS of claim 3, wherein the UAV is attached to one or more cameras, and the UAV is configured to recognize an event or a particular person.

5. The UAS of claim 4, wherein the UAV is configured to transmit the data based on the event or particular person.

6. The UAS of claim 1, further comprising:
a tether operably connected to the UAV at a first end and operably connected to a platform at a second end;
wherein the UAV is configured to receive data transmitted through the tether, and the data includes instructions commanding the UAV to return the platform.

7. The UAS of claim 1, wherein the UAV is attached to a robotic arm and the UAV is configured to carry advertising devices using the robotic arm.

8. The UAS of claim 1, wherein the UAV includes a maintenance bay housing a battery and the UAV is configured to return to a platform when the battery voltage is low.

9. The UAS of claim 1, wherein the UAV is configured to land on a platform configured to receive and protect the UAV.

10. The UAS of claim 9, wherein the UAV is configured to autonomously navigate within a predetermined area.

11. The UAS of claim 1, further comprising a controller, wherein the controller is configured to transmit one or more commands to the UAV, the one or more commands instructing the UAV to display an advertising message.

12. The UAS of claim 1, wherein the UAV attached to one or more projectors, and the UAV is configured to cause the projector to project an advertising message.

13. A method of displaying advertising messages, the method comprising:
providing an unmanned aerial vehicle (UAV) connected to a display screen;
transmitting, by the UAV, data to the display screen,
wherein the display screen is configured to display a message based on the transmitted data.

14. The method of claim 13, wherein the display screen includes one or more self-contained screens.

15. The method of claim 13, further comprising
determining, by the UAV, that UAV power is low;
navigating the UAV back to a platform;
opening a maintenance bay located in the UAV;
swapping a first battery located in the maintenance bay with a second battery located in the platform.

16. An unmanned aerial system (UAS) comprising:
an unmanned aerial vehicle (UAV);
a controller configured to transmit one or more commands to the UAV;
a connector, integral to the UAV, configured to carry an object; and
a power source configured to provide power to the UAV.

17. The UAS of claim 16, wherein the UAV is configured to receive at the connector at least one robotic arm, and the robotic arm is configured to hold an advertising message.

18. The UAS of claim 17, wherein the UAV is configured autonomously navigate within a programmed area, and the UAV is further configured to display a message in response to identifying a specific event.

19. The UAS of claim 16 further comprises a second UAV, wherein both UAVs are configured to collectively lift a platform, the platform including fireworks.

20. The UAS of claim 19, wherein at least one of the UAVs is configured to launch fireworks from the platform.
